(19) United States
(12) Patent Application Publication
(10) Pub. No.: US 2026/0318701 A1
(43) Pub. Date: Oct. 15, 2026

(54) METHOD, APPARATUS, AND DEVICE FOR DISPLAYING DRIVING PATH OUTSIDE VEHICLE, AND STORAGE MEDIUM

(71) Applicants: ZHEJIANG GEELY HOLDING GROUP CO., LTD., Hangzhou (CN); GEELY AUTOMOBILE RESEARCH INSTITUTE (NINGBO) CO., LTD., Ningbo (CN)

(72) Inventors: Fumin ZHENG, Hangzhou (CN); Linhui CHEN, Hangzhou (CN); Dongchun XU, Hangzhou (CN); Zhengkai LIAO, Hangzhou (CN); Lisheng HOU, Hangzhou (CN)

(73) Assignees: ZHEJIANG GEELY HOLDING GROUP CO., LTD., Hangzhou (CN); GEELY AUTOMOBILE RESEARCH INSTITUTE (NINGBO) CO., LTD., Ningbo (CN)

(21) Appl. No.: 19/688,961

(22) Filed: May 27, 2026

Related U.S. Application Data
(63) Continuation of application No. PCT/CN2024/133890, filed on Nov. 22, 2024.

(30) Foreign Application Priority Data
Dec. 25, 2023 (CN) 202311805487.6

(51) Int. Cl. G01C 21/36; B60Q 1/48; B60Q 1/50

(52) U.S. Cl. CPC G01C 21/365; B60Q 1/488; B60Q 1/50; B60Q 2400/50

(57) ABSTRACT

A method for displaying the driving path outside the vehicle is applied to a vehicle equipped with a plurality of exterior display units. The method includes: acquiring a planned driving path of a to-be-displayed vehicle, and determining coordinate information corresponding to each path point in the planned driving path; determining a to-be-displayed number corresponding to each coordinate information based on a preset mapping relationship, where the to-be-displayed number is a number corresponding to an exterior display unit; and displaying the planned driving path outside the vehicle through the exterior display unit corresponding to the to-be-displayed number.

### CROSS-REFERENCE TO RELATED APPLICATIONS

The present application is a continuation application of International Application No. PCT/CN2024/133890, filed on Nov. 22, 2024, which claims priority to Chinese Patent Application No. 202311805487.6, filed on Dec. 25, 2023. All of the aforementioned applications are incorporated herein by reference in their entireties.

### TECHNICAL FIELD

The present application relates to the technical field of vehicle, and in particular to method, an apparatus, and a device for displaying a driving path outside a vehicle, and a storage medium.

### BACKGROUND

Currently, with the development of technology, people are increasingly relying on intelligent driving for travel, and functions such as automatic low-speed vehicle control are gradually entering people's lives, such as automatic reversing into parking spaces.

However, in the current automatic vehicle control process, pedestrians outside the vehicle are unaware of the vehicle's driving path and may accidentally enter the driving path. If the vehicle does not recognize them in time, it may cause harm to pedestrians, resulting in low safety.

The above content is only used to help understand the technical solution of the present application and does not represent an admission that the above content is related art.

### SUMMARY

The main objective of the present application is to provide a method, an apparatus, and a device for displaying a driving path outside a vehicle, and a storage medium, aiming to solve the technical problem in the related art where pedestrians outside the vehicle are unaware of the vehicle's driving path and are prone to accidentally enter the driving path, resulting in low safety.

To achieve the above objectives, the present application provides a method for displaying a driving path outside a vehicle. The method is applied to a vehicle equipped with a plurality of exterior display units, and includes the following steps:
acquiring a planned driving path of a to-be-displayed vehicle, and determining coordinate information corresponding to each path point in the planned driving path;
determining a to-be-displayed number corresponding to each coordinate information based on a preset mapping relationship, where the to-be-displayed number is a number corresponding to an exterior display unit; and
displaying the planned driving path outside the vehicle through the exterior display unit corresponding to the to-be-displayed number.

In an embodiment, the acquiring the planned driving path of the to-be-displayed vehicle, and determining coordinate information corresponding to each path point in the planned driving path includes:
acquiring the planned driving path of the to-be-displayed vehicle, and determining current driving path within a preset distance threshold according to the planned driving path and a current position of the to-be-displayed vehicle; and
determining coordinate information corresponding to each path point in the current driving path; and
the displaying the planned driving path outside the vehicle through the exterior display unit corresponding to the to-be-displayed number includes:
displaying the current driving path outside the vehicle through the exterior display unit corresponding to the to-be-displayed number.

In an embodiment, after the acquiring the planned driving path of the to-be-displayed vehicle, the method further includes:
determining whether a current driving state of the to-be-displayed vehicle is a parking entry state based on the planned driving path;
in response to that the current driving state of the to-be-displayed vehicle is the parking entry state, acquiring a parking space position of a target parking space, and determining a parking entry distance between the current position of the to-be-displayed vehicle and the parking space position; and
in response to that the parking entry distance exceeds the preset distance threshold, determining the current driving path within the preset distance threshold according to the planned driving path and the current position of the to-be-displayed vehicle.

In an embodiment, after the determining the parking entry distance between the current position of the to-be-displayed vehicle and the parking space position, the method further includes:
in response to that the parking entry distance does not exceed the preset distance threshold, taking the parking entry distance as the preset distance threshold, and determining the current driving path within the preset distance threshold according to the planned driving path and the current position of the to-be-displayed vehicle.

In an embodiment, after the determining the coordinate information corresponding to each path point in the current driving path, the method further includes:
acquiring a current gear of the to-be-displayed vehicle, and determining a current driving direction according to the current gear; and
after the displaying the current driving path outside the vehicle through the exterior display unit corresponding to the to-be-displayed number, the method further includes:
displaying the current driving direction outside the vehicle through the exterior display unit.

In an embodiment, before the acquiring the planned driving path of the to-be-displayed vehicle, the method further includes:
acquiring a display area corresponding to each of the exterior display units, and determining coordinate information corresponding to each display area;
acquiring a number corresponding to each of the exterior display units, and constructing a preset mapping relationship based on each coordinate information and the corresponding number.

In an embodiment, before the acquiring the planned driving path of the to-be-displayed vehicle, the method further includes:
acquiring a current vehicle speed of the to-be-displayed vehicle, and determining whether the current vehicle speed is lower than a preset vehicle speed threshold; and
in response to that the current vehicle speed is lower than a preset vehicle speed threshold, acquiring the planned driving path of the to-be-displayed vehicle.

Furthermore, to achieve the above objectives, the present application also proposes apparatus for displaying a driving path outside a vehicle, including a coordinate determination module, a number determination module and a path display module.

The coordinate determination module is configured to acquire a planned driving path of a to-be-displayed vehicle, and determine coordinate information corresponding to each path point in the planned driving path.

The number determination module is configured to determine a to-be-displayed number corresponding to each coordinate information based on a preset mapping relationship. The to-be-displayed number is a number corresponding to an exterior display unit.

The path display module is configured to display the planned driving path outside the vehicle through the exterior display unit corresponding to the to-be-displayed number.

In addition, to achieve the above objectives, the present application also proposes a device for displaying a driving path outside a vehicle, including a memory, a processor, and a program for displaying a driving path outside a vehicle stored in the memory and executable on the processor, and the program for displaying the driving path outside the vehicle is configured to implement the steps of the method for displaying the driving path outside the vehicle as described above.

In addition, to achieve the above objectives, the present application also proposes a storage medium storing a program for displaying a driving path outside a vehicle, which, when executed by a processor, implements the steps of the method for displaying the driving path outside the vehicle described above.

The present application provides a method, an apparatus, and a device for displaying a driving path outside a vehicle, and a storage medium. The method is applied to a vehicle equipped with a plurality of exterior display units. The method includes acquiring a planned driving path of a to-be-displayed vehicle, and determining coordinate information corresponding to each path point in the planned driving path; determining a to-be-displayed number corresponding to each coordinate information based on a preset mapping relationship, where the to-be-displayed number is a number corresponding to an exterior display unit; and displaying the planned driving path outside the vehicle through the exterior display unit corresponding to the to-be-displayed number. Because the present application can first determine each path point in the acquired planned driving path, then determine the coordinate information corresponding to each path point, determine the to-be-displayed number corresponding to each coordinate information based on a preset mapping relationship, and display the planned driving path outside the vehicle through the exterior display unit corresponding to the to-be-displayed number. Compared to existing methods where pedestrians cannot see the vehicle's driving path, the present application can display the planned driving path outside the vehicle for pedestrians to observe, preventing accidental entry and improving safety.

### BRIEF DESCRIPTION OF THE DRAWINGS

FIG. 1 is a structure schematic diagram of a device for displaying a driving path outside a vehicle in the hardware operating environment according to an embodiment of the present application.

FIG. 2 is a flowchart of a method for displaying a driving path outside a vehicle according to an embodiment of the present application.

FIG. 3 is a top view of path display in the method for displaying the driving path outside the vehicle according to the present application.

FIG. 4 is a side view of path display in the method for displaying the driving path outside the vehicle according to the present application.

FIG. 5 is a schematic diagram of a planned driving path in the method for displaying the driving path outside the vehicle according to the present application.

FIG. 6 is a structure schematic diagram of an exterior display unit in the method displaying the driving path outside the vehicle according to the present application.

FIG. 7 is a flowchart of the method for displaying the driving path outside the vehicle according to another embodiment of the present application.

FIG. 8 is a flowchart of the method for displaying the driving path outside the vehicle according to another embodiment of the present application.

FIG. 9 is a structural block diagram of the method for displaying the driving path outside the vehicle according to an embodiment of the present application.

The realization of the purpose, functional features and advantages of the present application will be further explained in conjunction with the embodiments and with reference to the accompanying drawings.

### DETAILED DESCRIPTION OF THE EMBODIMENTS

It should be understood that the specific embodiments described herein are for illustrative purposes only and are not intended to limit the scope of the present application.

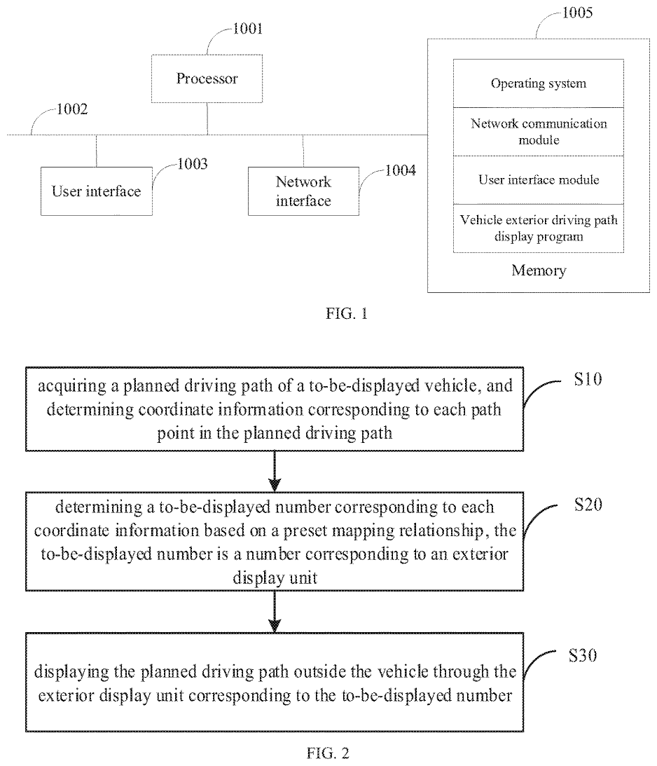

Referring to FIG. 1, which is a structure schematic diagram of a device for displaying a driving path outside a vehicle in the hardware operating environment according to an embodiment of the present application.

As shown in FIG. 1, the device for displaying a driving path outside a vehicle may include: a processor 1001, such as a central processing unit (CPU), a communication bus 1002, a user interface 1003, a network interface 1004 and a memory 1005. The communication bus 1002 is used to enable communication between these components. The user interface 1003 may include a display screen and an input unit such as a keyboard. The user interface 1003 may also include standard wired and wireless interfaces. The network interface 1004 may include standard wired and wireless interfaces (such as a wireless-fidelity (Wi-Fi) interface). The memory 1005 may be high-speed random access memory (RAM) or stable non-volatile memory (NVM), such as a disk drive. The memory 1005 may also be a storage device independent of the aforementioned processor 1001.

Those skilled in the art will understand that the structure shown in FIG. 1 does not constitute a limitation on the device for displaying the driving path outside the vehicle, and may include more or fewer components than shown, or a combination of certain components, or differently arranged components.

As shown in FIG. 1, the memory 1005, which serves as a storage medium, may include an operating system, a network communication module, a user interface module, and a program for displaying a driving path outside a vehicle.

In the device for displaying a driving path outside a vehicle shown in FIG. 1, the network interface 1004 is mainly used for data communication with the network server; the user interface 1003 is mainly used for data interaction with the user; the processor 1001 and the memory 1005 can be set in the device for displaying a driving path outside a vehicle. The device for displaying the driving path outside the vehicle calls the program for displaying the driving path outside the vehicle stored in the memory 1005 through the processor 1001 and executes the method for displaying the driving path outside the vehicle provided in the embodiment of the present application.

The present application provides a method for displaying a driving path outside a vehicle. Referring to FIG. 2, FIG. 2 is a flowchart of a method for displaying the driving path outside the vehicle according to an embodiment of the present application.

In this embodiment, the method for displaying the driving path outside the vehicle includes the following steps.

Step S10: acquiring a planned driving path of a to-be-displayed vehicle, and determining coordinate information corresponding to each path point in the planned driving path.

Currently, with the development of technology, people are increasingly relying on intelligent driving for travel, and functions such as automatic low-speed vehicle control are gradually entering people's lives, such as automatic reversing into parking spaces.

However, in the current automatic vehicle control process, pedestrians outside the vehicle are unaware of the vehicle's driving path and may accidentally enter the driving path. If the vehicle does not recognize them in time, it may cause harm to pedestrians, resulting in low safety.

Therefore, in order to solve the above-mentioned defects, this embodiment can display the planned driving path outside the vehicle so that pedestrians can observe it and prevent them from accidentally entering it. Compared with the existing method where pedestrians outside the vehicle cannot know the vehicle's driving path, this embodiment improves safety.

The method described in this embodiment can be applied to scenarios involving automated vehicle control. The executing entity of this method can be a computing service device with functions such as vehicle exterior display of a driving path, network communication, and program execution, such as a vehicle with several exterior display units, or other electronic devices that perform the same or similar functions. The following description uses the aforementioned device for displaying a driving path outside a vehicle (hereinafter referred to as the device) to illustrate this embodiment and the subsequent embodiments.

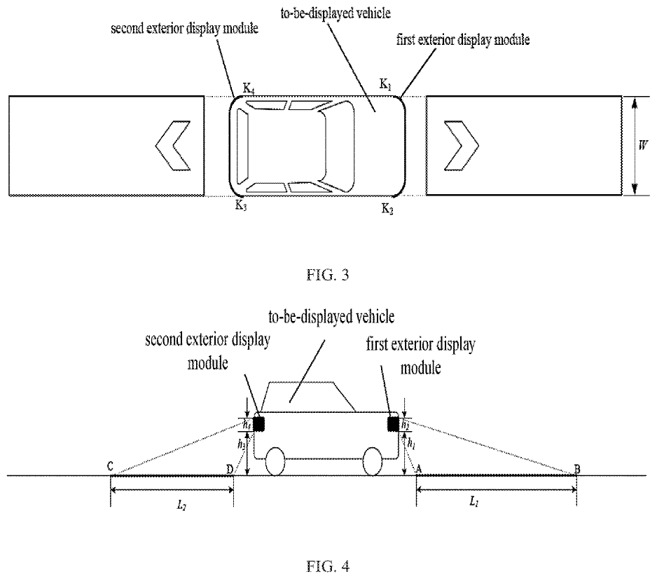

The aforementioned exterior display unit can be a unit used to display a path, and the aforementioned to-be-displayed vehicle can be a vehicle that needs to be displayed externally. Several of the aforementioned exterior display units can be installed on the aforementioned to-be-displayed vehicle. For ease of understanding, please refer to FIG. 3 and FIG. 4 for explanation. FIG. 3 is a top view of path display in the method for displaying the driving path outside the vehicle according to the present application, and FIG. 4 is a side view of path display in the method for displaying the driving path outside the vehicle according to the present application. As shown in FIG. 3, several exterior display units can be installed in front of and behind the to-be-displayed vehicle. The several exterior display units in front can constitute a first exterior display module, and the several exterior display units in the rear can constitute a second exterior display module. K₁, K₂, K₃ and K₄ are all extreme positions for the installation of the first or second exterior display module. The specific installation position and the specific number of exterior display units can be set according to the actual situation. This embodiment does not limit this.

In FIG. 3, the path corresponding to forward movement can be displayed on the ground through the first exterior display module, where W is the width of the displayed path. The path corresponding to backward movement can be displayed through the second exterior display module, and the width can be the same as the path corresponding to forward movement, which can both be the width of the vehicle body.

As shown in FIG. 4, the ground clearance of the first exterior display module can be h₁, and its own height can be h₂. The ground clearance of the second exterior display module can be h₃, and its own height can be h₄. The specific heights can be set according to the actual situation. Among them, h₁ can be the same as h₃, and h₂ can be the same as h₄.

As shown in FIG. 4, the path length displayed on the ground by the first exterior display module can be L₁, which is the distance AB in FIG. 4. The path length displayed on the ground by the second exterior display module can be L₂, which is the distance CD in FIG. 4. Both L₁ and L₂ can be set by adjusting the illumination angle and number of the exterior display units. The larger the illumination angle, the farther the distance. The more exterior display units there are, the farther the distance is, and the clearer the path is.

The above-mentioned planned driving path can be a pre-planned driving path for the to-be-displayed vehicle. For example, if the user needs the to-be-displayed vehicle to perform automatic reverse parking, after the user determines the corresponding parking space, the to-be-displayed vehicle can plan a driving path based on its own position and the position of the parking space, which will be the above-mentioned planned driving path. Then, it can drive according to the planned driving path to complete reverse parking.

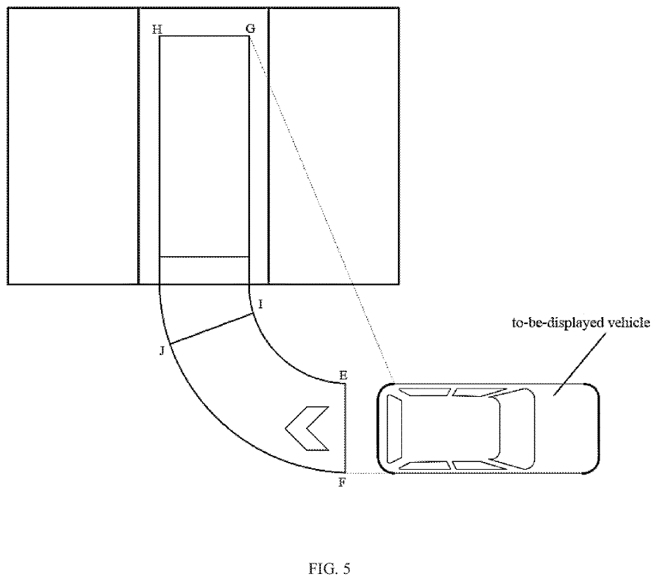

The planned driving path can be composed of several path points. For ease of understanding, refer to FIG. 5, which is a schematic diagram of a planned driving path in the method for displaying the driving path outside the vehicle according to the present application. As shown in FIG. 5, if the to-be-displayed vehicle is performing automatic reverse parking and needs to drive from position EF to position HG, then the paths corresponding to EG and FH are the planned driving paths mentioned above. The four line segments FG, GH, HF and FE can all be composed of several path points, and each path point can correspond to a coordinate information. In this embodiment, the center position of the to-be-displayed vehicle can be used as the origin to construct a rectangular coordinate system, and then the corresponding coordinate information can be generated according to the position of each path point.

In a specific implementation, the device can obtain the planned driving path of the to-be-displayed vehicle, determine the path points in the planned driving path, construct a rectangular coordinate system based on the center position of the to-be-displayed vehicle, and determine the coordinate information corresponding to each path point based on the rectangular coordinate system.

Step S20: determining a to-be-displayed number corresponding to each coordinate information based on a preset mapping relationship. The to-be-displayed number is a number corresponding to an exterior display unit.

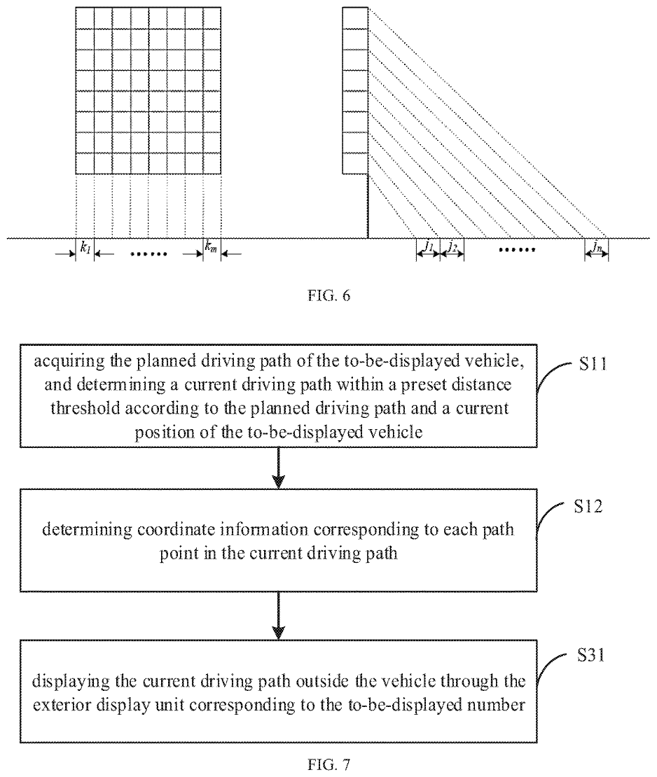

The aforementioned preset mapping relationship can be the relationship between coordinate information and the corresponding to-be-displayed number. In this embodiment, an LED light can be installed inside the exterior display unit, which can project the path onto the ground. To facilitate the control of the corresponding exterior display unit for display, each exterior display unit can be numbered. Referring to FIG. 6, FIG. 6 is a structure schematic diagram of an exterior display unit in the method for displaying the driving path outside the vehicle according to the present application. As shown in FIG. 6, in this embodiment, both the first exterior display module and the second exterior display module can be composed of m×n exterior display units, where m units can be set in a row along the horizontal axis and n units can be set in a column along the vertical axis. The projection width of each exterior display unit is k, i.e., k₁ . . . kₘ in FIG. 4, and the projection length of each exterior display unit is j, i.e., j₁, j₂ . . . jₙ in FIG. 4. The specific values can be adjusted according to the actual situation, and this embodiment does not impose any restrictions on them.

The aforementioned device can pre-construct the preset mapping relationship based on the correspondence between the position projected by each exterior display unit on the ground and the coordinate information of that position. The specific steps are as follows.

Before the step of acquiring the planned driving path of the to-be-displayed vehicle, the method further includes:
acquiring a display area corresponding to each of the exterior display units, and determining coordinate information corresponding to each display area; and
acquiring a number corresponding to each of the exterior display units, and constructing a preset mapping relationship based on each coordinate information and the corresponding number.

The aforementioned display area can be the area projected onto the ground by the exterior display unit. In this embodiment, the display areas projected by all exterior display units can be pre-divided to obtain corresponding rectangular frames. Each rectangular frame can correspond to one or more coordinate points. If one rectangular frame corresponds to one coordinate point, then one to-be-displayed number corresponds to one coordinate information. If one rectangular frame corresponds to multiple coordinate points, then one to-be-displayed number can correspond to multiple coordinate information. Thus, the aforementioned preset mapping relationship can be constructed based on the coordinate information and the corresponding number.

In practical implementation, the aforementioned device can determine the display number corresponding to each coordinate information based on a preset mapping relationship.

Step S30: displaying the planned driving path outside the vehicle through the exterior display unit corresponding to the to-be-displayed number.

In practical implementation, after determining the to-be-displayed number, the device can control the exterior display unit corresponding to the to-be-displayed number to light up and display the planned driving path outside the vehicle.

Furthermore, considering that displaying the planned driving path outside the vehicle is less practical when the vehicle speed is high, in this embodiment, before the step of acquiring the planned driving path of the to-be-displayed vehicle, the method further includes:
acquiring a current vehicle speed of the to-be-displayed vehicle, and determining whether the current vehicle speed is lower than a preset vehicle speed threshold; and
in response to that the current vehicle speed is lower than a preset vehicle speed threshold, acquiring the planned driving path of the to-be-displayed vehicle.

The aforementioned preset vehicle speed threshold can be used to determine whether the current vehicle speed is too high. It can be set according to the actual situation. In this embodiment, the device can obtain the current speed of the to-be-displayed vehicle and determine whether the current speed is lower than the preset vehicle speed threshold. If so, it means that the to-be-displayed vehicle is in a low-speed driving state and can perform vehicle exterior display. If not, it means that the to-be-displayed vehicle is in a high-speed driving state and performing vehicle exterior display may affect the driver's driving. At the same time, pedestrians outside the vehicle generally do not appear on the road where the speed is high. Therefore, the device can not perform vehicle exterior display, which saves energy and improves practicality.

The aforementioned device may further select the activation time of the vehicle exterior display according to user requirements. That is, the vehicle exterior display may be activated both when the user manually drives the to-be-displayed vehicle and when the to-be-displayed vehicle performs automatic vehicle control, or the vehicle exterior display may be activated only during automatic vehicle control. If the display is activated in both manual driving and automatic vehicle control modes, the aforementioned device may perform display upon detecting that the current vehicle speed is lower than the preset vehicle speed threshold. If the display is activated only during automatic vehicle control, the above-mentioned device may detect whether the to-be-displayed vehicle is in an automatic vehicle control state; if yes, the device further detects whether the current vehicle speed is lower than the preset vehicle speed threshold.

In this embodiment, the device can pre-acquire the display area corresponding to each exterior display unit and construct a preset mapping relationship based on the coordinate information corresponding to each display area and the corresponding number of the exterior display unit. In actual use, the device can determine whether the current vehicle speed is lower than a preset vehicle speed threshold. If so, it can acquire the planned driving path of the to-be-displayed vehicle and determine the path points in the planned driving path. A rectangular coordinate system is constructed based on the center position of the to-be-displayed vehicle, and the coordinate information corresponding to each path point is determined based on the rectangular coordinate system. The to-be-displayed number corresponding to each coordinate information is determined based on the preset mapping relationship, and the planned driving path is displayed externally through the exterior display unit corresponding to the to-be-displayed number. Since this embodiment can display the planned driving path outside the vehicle for pedestrians to observe and prevent accidental entry, compared to existing methods where pedestrians cannot know the vehicle's driving path, this embodiment improves safety. At the same time, because the vehicle's driving path is indicated to pedestrians outside the vehicle, pedestrians will not enter the driving area, thus improving the vehicle's driving efficiency.

Referring to FIG. 7, which is a flowchart of a method for displaying the driving path outside the vehicle according to another embodiment of the present application.

Considering the limited number of exterior display units, when the distance of the planned driving path is relatively long, the exterior display units may fail to display the entire planned driving path outside the vehicle. Therefore, in the present embodiment, only a part of the path is displayed, and the displayed path is updated in real time according to the current position of the to-be-displayed vehicle. As shown in FIG. 7, in this embodiment, step S10 includes the following steps.

Step S11: acquiring the planned driving path of the to-be-displayed vehicle, and determining a current driving path within a preset distance threshold according to the planned driving path and a current position of the to-be-displayed vehicle.

The aforementioned preset distance threshold can be the farthest distance that the exterior display unit can support displaying. As shown in FIG. 4, for the first exterior display module, the farthest distance that can be displayed can be L₁, and for the second exterior display module, the farthest distance that can be displayed can be L₂. The aforementioned preset distance threshold can be the value corresponding to L₁ and L₂. This embodiment does not impose any specific limitations.

The aforementioned current driving path can be the path that the to-be-displayed vehicle can display within the planned driving path. As shown in FIG. 5, if the path from EF to GH is the aforementioned planned driving path, but since the distance that the second exterior display module can display is L₂, the path between EF and IJ can be displayed through the second exterior display module. The path between EF and IJ is the aforementioned current driving path.

Step S12: determining coordinate information corresponding to each path point in the current driving path.

Accordingly, step S30 above includes the following steps.

Step S31: displaying the current driving path outside the vehicle through the exterior display unit corresponding to the to-be-displayed number.

In practical implementation, after determining the current driving path, the above-mentioned device can determine the coordinate information corresponding to each path point in the current driving path, and determine the to-be-displayed number corresponding to each coordinate information according to the mapping relationship. Finally, it controls the to-be-displayed unit corresponding to the to-be-displayed number to light up so as to project the current driving path onto the ground for external display, thereby displaying the current driving path in real time according to the current position.

In an embodiment, considering that the to-be-displayed vehicle will not continue driving after automatically reversing into a parking space, and only the path to the parking space needs to be displayed, in this embodiment, after the step of acquiring the planned driving path of the to-be-displayed vehicle, the method further includes the following steps.

Determining whether a current driving state of the to-be-displayed vehicle is a parking entry state based on the planned driving path.

The current driving state of the to-be-displayed vehicle can be divided into parking entry state and normal driving state. If it is in parking entry state, it means that the to-be-displayed vehicle is performing reverse parking. Other driving states besides reverse parking can be called the above-mentioned normal driving state. The device can determine whether it is in parking entry state based on the destination of the planned driving path. If the destination is a parking space, it is determined to be in parking entry state. It can also be determined by other methods. For example, when the user clicks the automatic parking function button, it can be determined that the purpose of the generated planned driving path is to enter a parking space, and thus the to-be-displayed vehicle can be determined to be in parking entry state.

In response to that the current driving state of the to-be-displayed vehicle is the parking entry state, acquiring a parking space position of a target parking space, and determining a parking entry distance between the current position of the to-be-displayed vehicle and the parking space position.

In response to that the parking entry distance exceeds the preset distance threshold, determining the current driving path within the preset distance threshold according to the planned driving path and the current position of the to-be-displayed vehicle.

The aforementioned device can determine the position of the target parking space from the planned driving path and determine the entry distance between the current position and the parking space position. The target parking space can be the parking space where the user needs to park. It can determine whether the entry distance exceeds a preset distance threshold. If it does, it means that the entry distance is still too long and the exterior display unit cannot display it completely. Therefore, it can only display the current driving path within the preset distance threshold.

In an embodiment, after the step of determining the parking entry distance between the current position of the to-be-displayed vehicle and the parking space position, the method further includes the following steps.

In response to that the parking entry distance does not exceed the preset distance threshold, taking the parking entry distance as the preset distance threshold, and determining the current driving path within the preset distance threshold according to the planned driving path and the current position of the to-be-displayed vehicle.

If the parking entry distance does not exceed the preset distance threshold, it indicates that the remaining parking entry distance is short, and the exterior display unit can display it completely. Since the to-be-displayed vehicle will stop after parking in the parking space and will not continue to move, the parking entry distance can be used as the preset distance threshold in real time to display the current driving path between the vehicle and the parking space As shown in FIG. 5, if the parking entry distance does not exceed the preset distance threshold, the second exterior display module only needs to display the current driving path up to the position GH in real time, and no display is provided beyond HG, which can save energy.

If the current driving state of the to-be-displayed vehicle is normal driving state, the current driving path can be displayed directly.

In this embodiment, the device can acquire the planned driving path of the to-be-displayed vehicle, determine the current driving path within a preset distance threshold that can be supported for display based on the current position of the to-be-displayed vehicle, determine the coordinate information corresponding to each path point in the current driving path, and determine the to-be-displayed number corresponding to each coordinate information according to the mapping relationship. Finally, it controls the to-be-displayed unit corresponding to the to-be-displayed number to light up, so as to project the current driving path onto the ground for external display. Thus, the current driving path can be displayed in real time according to the current position, without displaying the entire planned driving path, which achieves the purpose of external display and also reduces the number of exterior display units. At the same time, before performing vehicle exterior display, the device can determine whether the current driving state of the to-be-displayed vehicle is in the parking entry state. If not, the current driving path is directly displayed. If so, the parking entry distance between the current position of the to-be-displayed vehicle and the parking space position of the target parking space is determined, and it is determined whether the parking entry distance exceeds a preset distance threshold. If so, the current driving path within the preset distance threshold is displayed. If not, only the current driving path corresponding to the parking entry distance is displayed in real time.

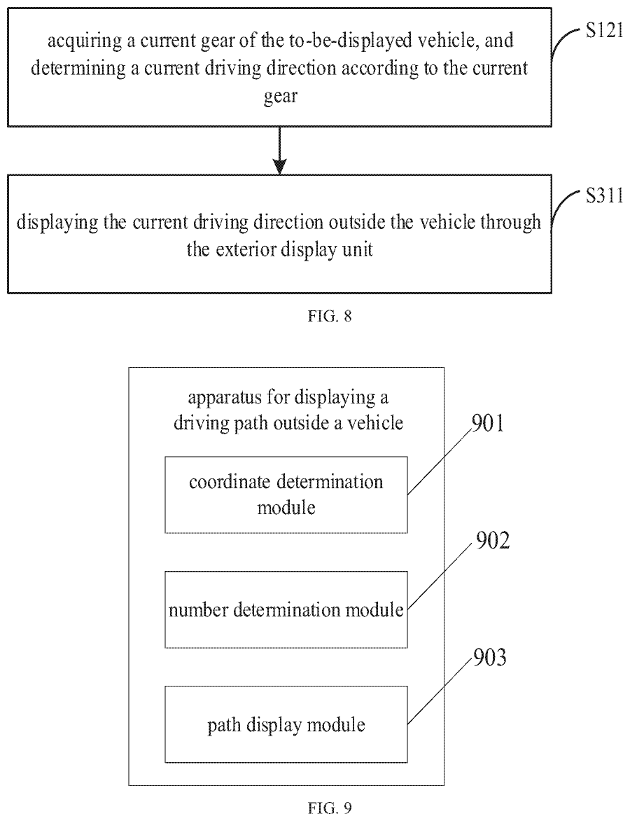

Referring to FIG. 8, which is a flowchart of a method for displaying the driving path outside the vehicle according to another embodiment of the present application.

To facilitate pedestrians outside the vehicle in understanding the driving direction of the to-be-displayed vehicle, as shown in FIG. 8, in this embodiment, after the above-mentioned step of determining the coordinate information corresponding to each path point in the current driving path, the method further includes the following steps.

Step S121: acquiring a current gear of the to-be-displayed vehicle, and determining a current driving direction according to the current gear.

Accordingly, step S31 above includes:
Step S311: displaying the current driving direction outside the vehicle through the exterior display unit.

The aforementioned current driving direction can be the current travel direction of to-be-displayed vehicle. After determining the coordinate information corresponding to each path point, the device can obtain the current gear of the to-be-displayed vehicle. If the current gear is a forward gear, it can be displayed outside the vehicle in the forward direction and display the identifier corresponding to the forward direction. If it is a reverse gear, it can be displayed outside the vehicle in the reverse direction and display the identifier corresponding to the reverse direction. As shown in FIG. 3, if it is a forward gear, the identifier corresponding to the forward direction can be displayed through the first exterior display module (the right arrow in FIG. 3). If it is a reverse gear, the identifier corresponding to the reverse direction can be displayed through the second exterior display module (the left arrow in FIG. 3). The specific identifier can also take other forms, and this embodiment does not limit this.

If the current gear is neither forward nor reverse, then the first or second exterior display module will not display the identifier.

This embodiment can determine the current driving direction based on the current gear of the to-be-displayed vehicle, and display the current driving direction outside the vehicle through the exterior display unit, making it easier for pedestrians outside the vehicle to observe and improving the user experience.

Furthermore, the present application embodiment also proposes a storage medium storing a program for displaying a driving path outside a vehicle, which, when executed by a processor, implements the steps of the method for displaying the driving path outside the vehicle described above.

Referring to FIG. 9, which is a structural block diagram of a method for displaying the driving path outside the vehicle according to an embodiment of the present application.

As shown in FIG. 9, the apparatus for displaying a driving path outside a vehicle proposed in this embodiment includes a coordinate determination module 901, number determination module 902 and path display module 903.

The coordinate determination module 901 is configured to acquire a planned driving path of a to-be-displayed vehicle, and determine coordinate information corresponding to each path point in the planned driving path.

The number determination module 902 is configured to determine a to-be-displayed number corresponding to each coordinate information based on a preset mapping relationship. The to be-displayed number is a number corresponding to an exterior display unit.

The path display module 903 is configured to display the planned driving path outside the vehicle through the exterior display unit corresponding to the to-be-displayed number.

In this embodiment, the device can pre-acquire the display area corresponding to each exterior display unit and construct a preset mapping relationship based on the coordinate information corresponding to each display area and the corresponding number of the exterior display unit. In actual use, the device can determine whether the current vehicle speed is lower than a preset vehicle speed threshold. If so, it can acquire the planned driving path of the to-be-displayed vehicle and determine the path points in the planned driving path. A rectangular coordinate system is constructed based on the center position of the to-be-displayed vehicle, and the coordinate information corresponding to each path point is determined based on the rectangular coordinate system. The to-be-displayed number corresponding to each coordinate information is determined based on the preset mapping relationship, and the planned driving path is displayed externally through the exterior display unit corresponding to the to-be-displayed number. Since this embodiment can display the planned driving path outside the vehicle for pedestrians to observe and prevent accidental entry, compared to existing methods where pedestrians cannot know the vehicle's driving path, this embodiment improves safety. At the same time, because the vehicle's driving path is indicated to pedestrians outside the vehicle, pedestrians will not enter the driving area, thus improving the vehicle's driving efficiency.

In one implementation, the coordinate determination module 901 is further configured to acquire a display area corresponding to each of the exterior display units, and determine coordinate information corresponding to each display area; and acquire a number corresponding to each of the exterior display units, and construct a preset mapping relationship based on each coordinate information and the corresponding number

In one implementation, the coordinate determination module 901 is further configured to acquire a current vehicle speed of the to-be-displayed vehicle, and judge whether the current vehicle speed is lower than a preset vehicle speed threshold; if so, execute the step of acquiring the planned driving path of the to-be-displayed vehicle.

Based on the above embodiment of the apparatus for displaying a driving path outside a vehicle described in the present application, another embodiment of the apparatus for displaying a driving path outside a vehicle of the present application is proposed.

In this embodiment, the coordinate determination module 901 is further configured acquire the planned driving path of the to-be-displayed vehicle, and determine a current driving path within a preset distance threshold according to the planned driving path and a current position of the to-be-displayed vehicle; and determine the coordinate information corresponding to each path point in the current driving path.

The path display module 903 is also configured to displaying the current driving path outside the vehicle through the exterior display unit corresponding to the to-be-displayed number.

In one implementation, the coordinate determination module 901 is further configured to determine whether the current driving state of the to-be-displayed vehicle is in a parking entry state based on the planned driving path; if so, it obtains the parking space position of the target parking space and determines the parking entry distance between the current position of the to-be-displayed vehicle and the parking space position; when the parking entry distance exceeds a preset distance threshold, it executes the step of determining the current driving path within the preset distance threshold according to the planned driving path and the current position of the to-be-displayed vehicle.

In one implementation, the coordinate determination module 901 is further configured to, when the parking entry distance does not exceed the preset distance threshold, take the parking entry distance as the preset distance threshold, and execute the step of determining the current driving path within the preset distance threshold according to the planned driving path and the current position of the to-be-displayed vehicle.

Based on the above embodiments of the apparatus for displaying a driving path outside a vehicle of the present application, another embodiment of the apparatus for displaying a driving path outside a vehicle of the present application is proposed.

In this embodiment, the coordinate determination module 901 is further configured obtain the current gear of the to-be-displayed vehicle, and determine the current driving direction based on the current gear.

The path display module 903 is also used to display the current driving direction outside the vehicle through the exterior display unit.

Other embodiments or specific implementations of the apparatus for displaying a driving path outside a vehicle of the present application can be found in the above-described method embodiments, and will not be repeated here.

In this document, the terms “comprising”, “including” or any other variations thereof are intended to cover non-exclusive inclusion, such that a process, method, article, or system that includes a list of elements includes not only those elements but also other elements not expressly listed, or elements inherent to such a process, method, article, or system. Without further limitation, an element defined by the phrase “comprising a . . . ” does not exclude the presence of other identical elements in the process, method, article, or system that includes that element.

The sequence numbers of the embodiments in the present application are for descriptive purposes only and do not represent the superiority or inferiority of the embodiments.

Through the above description of the embodiments, those skilled in the art can clearly understand that the methods of the above embodiments can be implemented by means of software plus necessary general-purpose hardware platforms. Of course, they can also be implemented by hardware, but in many cases the former is a better implementation method. Based on this understanding, the technical solution of the present application, in essence, or the part that contributes to the related art, can be embodied in the form of a software product. This computer software product is stored in a storage medium (such as read-only memory/random access memory, magnetic disk, optical disk) and includes several instructions to cause a terminal device (which may be a mobile phone, computer, server, or network device, etc.) to execute the methods described in the various embodiments of the present application.

The above are merely embodiments of the present application and do not limit the patent scope of the present application. Any equivalent structural or procedural transformations made using the content of the present application's specification and drawings, or direct or indirect applications in other related technical fields, are similarly included within the patent protection scope of the present application.

What is claimed is:

1. A method for displaying a driving path outside a vehicle, applied to the vehicle equipped with a plurality of exterior display units, comprising:
acquiring a planned driving path of a to-be-displayed vehicle, and determining coordinate information corresponding to each path point in the planned driving path;
determining a to-be-displayed number corresponding to each coordinate information based on a preset mapping relationship, wherein the to-be-displayed number is a number corresponding to an exterior display unit; and
displaying the planned driving path outside the vehicle through the exterior display unit corresponding to the to-be-displayed number.

2. The method for displaying the driving path outside the vehicle according to claim 1, wherein:
the acquiring the planned driving path of the to-be-displayed vehicle, and determining coordinate information corresponding to each path point in the planned driving path comprises:
acquiring the planned driving path of the to-be-displayed vehicle, and determining a current driving path within a preset distance threshold according to the planned driving path and a current position of the to-be-displayed vehicle; and
determining coordinate information corresponding to each path point in the current driving path; and
the displaying the planned driving path outside the vehicle through the exterior display unit corresponding to the to-be-displayed number comprises:
displaying the current driving path outside the vehicle through the exterior display unit corresponding to the to-be-displayed number.

3. The method for displaying the driving path outside the vehicle according to claim 2, wherein after the acquiring the planned driving path of the to-be-displayed vehicle, the method further comprises:
determining whether a current driving state of the to-be-displayed vehicle is a parking entry state based on the planned driving path;
in response to that the current driving state of the to-be-displayed vehicle is the parking entry state, acquiring a parking space position of a target parking space, and determining a parking entry distance between the current position of the to-be-displayed vehicle and the parking space position; and
in response to that the parking entry distance exceeds the preset distance threshold, determining the current driving path within the preset distance threshold according to the planned driving path and the current position of the to-be-displayed vehicle.

4. The method for displaying the driving path outside the vehicle according to claim 3, wherein after the determining the parking entry distance between the current position of the to-be-displayed vehicle and the parking space position, the method further comprises:
in response to that the parking entry distance does not exceed the preset distance threshold, taking the parking entry distance as the preset distance threshold, and determining the current driving path within the preset distance threshold according to the planned driving path and the current position of the to-be-displayed vehicle.

5. The method for displaying the driving path outside the vehicle according to claim 2, wherein:
after the determining the coordinate information corresponding to each path point in the current driving path, the method further comprises:
acquiring a current gear of the to-be-displayed vehicle, and determining a current driving direction according to the current gear; and
after the displaying the current driving path outside the vehicle through the exterior display unit corresponding to the to-be-displayed number, the method further comprises:
displaying the current driving direction outside the vehicle through the exterior display unit.

6. The method for displaying the driving path outside the vehicle according to claim 1, wherein before the acquiring the planned driving path of the to-be-displayed vehicle, the method further comprises:
acquiring a display area corresponding to each of the exterior display units, and determining coordinate information corresponding to each display area; and
acquiring a number corresponding to each of the exterior display units, and constructing a preset mapping relationship based on each coordinate information and the corresponding number.

7. The method for displaying the driving path outside the vehicle according to claim 1, wherein before the acquiring the planned driving path of the to-be-displayed vehicle, the method further comprises:
acquiring a current vehicle speed of the to-be-displayed vehicle, and determining whether the current vehicle speed is lower than a preset vehicle speed threshold; and
in response to that the current vehicle speed is lower than a preset vehicle speed threshold, acquiring the planned driving path of the to-be-displayed vehicle.

8. The method for displaying the driving path outside the vehicle according to claim 1, wherein the acquiring the planned driving path of the to-be-displayed vehicle and determining coordinate information corresponding to each path point in the planned driving path comprises:
acquiring the planned driving path of the to-be-displayed vehicle, and determining path points in the planned driving path;
constructing a rectangular coordinate system based on a center position of the to-be-displayed vehicle; and
determining the coordinate information corresponding to each path point based on the rectangular coordinate system.

9. The method for displaying the driving path outside the vehicle according to claim 1, wherein after the determining the to-be-displayed number corresponding to each coordinate information based on the preset mapping relationship, the method further comprises:
controlling the exterior display unit corresponding to the to-be-displayed number to light up, and displaying the corresponding planned driving path outside the vehicle.

10. The method for displaying the driving path outside the vehicle according to claim 1, wherein a current driving state of the to-be-displayed vehicle is divided into a parking entry state and a normal driving state.

11. An apparatus for displaying a driving path outside a vehicle, comprising:
a coordinate determination module, configured to acquire a planned driving path of a to-be-displayed vehicle, and determine coordinate information corresponding to each path point in the planned driving path;
a number determination module, configured to determine a to-be-displayed number corresponding to each coordinate information based on a preset mapping relationship, wherein the to-be-displayed number is a number corresponding to an exterior display unit; and
a path display module, configured to display the planned driving path outside the vehicle through the exterior display unit corresponding to the to-be-displayed number.

12. A device for displaying a driving path outside a vehicle, comprising:
a memory;
a processor; and
a program for displaying the driving path outside the vehicle stored on the memory and executable on the processor, wherein the program for displaying the driving path outside the vehicle is configured to implement the steps of the method for displaying the driving path outside the vehicle according to claim 1.

13. A non-transitory computer-readable storage medium, wherein a program for displaying a driving path outside a vehicle is stored on the storage medium, and when executed by a processor, the program for displaying the driving path outside the vehicle implements the steps of the method for displaying the driving path outside the vehicle according to claim 1.
